(19) United States
(12) Patent Application Publication
(10) Pub. No.: US 2023/0350974 A1
(43) Pub. Date: Nov. 2, 2023

(54) Quantitative Computation Method and Apparatus Applied to Depthwise Convolution

(71) Applicant: Shenzhen Corerain Technologies Co., Ltd., Shenzhen, Guangdong (CN)

(72) Inventors: Xiayang Zhou, Shenzhen (CN); Kuen Hung Tsoi, Shenzhen (CN); Xinyu Niu, Shenzhen (CN)

(21) Appl. No.: 18/177,825

(22) Filed: Mar. 3, 2023

(30) Foreign Application Priority Data
Apr. 1, 2022 (CN) 202210338705.9

(51) Int. Cl. G06F 17/11; G06F 7/523

(52) U.S. Cl. CPC G06F 17/11; G06F 7/523

(57) ABSTRACT

The present application provides a quantitative computation method and apparatus applied to depthwise convolution. The method includes: determining n multipliers adopted for standard convolution in a preset part of quantitative computation; equally distributing the n multipliers to a first part and a second part of depthwise convolution in the quantitative computation; in the depthwise convolution, computing a first result of a target pixel point in a target block unit in the first part by one multiplier in the first part, and computing a second result of the target pixel point in the second part by one multiplier in the second part; and obtaining quantified results of the target block unit specific to the first part and the second part according to the first result and the second result of each target pixel point. According to the present application, resources are utilized to the maximum extent.

### CROSS REFERENCE TO RELATED APPLICATIONS

The present application claims the benefit of Chinese Patent Application No. 202210338705.9 filed on Apr. 1, 2022, the contents of which are incorporated herein by reference in their entirety.

### TECHNICAL FIELD

The present application relates to the technical field of neural networks, in particular to a quantitative computation method and apparatus applied to depthwise convolution.

### BACKGROUND

With the rapid development of deep learning, a convolutional neural network has been widely applied to machine vision such as image recognition and image classification. An input image has a plurality of channels. In standard convolution, each convolution kernel operates all the channels of the input image at the same time; and in depthwise convolution, each convolution kernel is only responsible for one channel.

During quantitative computation of convolution, a first part ∑(q_{d}*q_{w}), a second part Z_{w} ∑(q_{d}) and a third part Zₒ +S(∗) are needed to be computed, wherein “*” in the third part includes the first part and the second part. In the first part, each convolution kernel in the standard convolution is responsible for all the channels at the same time, and therefore, the first part ∑(q_{d} ∗ q_{w}) needs to compute results of all the channels at the same time, that is, q_{d}*q_{w} is computed once for each channel, so that a plurality of multipliers are needed in the first part.

If depthwise convolution is adopted for quantitative computation specific to the above-mentioned formulae, each convolution kernel is only responsible for one channel, and therefore, during quantitative computation in the first part, the depthwise convolution only requires to compute q_{d} ∗ q_{w} for one channel, that is, one multiplier is used, which causes resource waste of other multipliers used for computing the first part in a computing system.

### SUMMARY

Objectives of embodiments of the present application are to provide a quantitative computation method and apparatus applied to depthwise convolution to solve the problem of resource waste. Specific technical solutions are shown as follows:

In a first aspect, a quantitative computation method applied to depthwise convolution is provided. The method includes:
determining n multipliers adopted for standard convolution in a preset part of quantitative computation, wherein n is the number of channels in the standard convolution;
equally distributing the n multipliers to a first part and a second part of depthwise convolution in the quantitative computation, wherein the first part and the second part are both parts of formulae in quantification formulae, the first part is the same as the preset part, quantified results of m block units in an input image can be computed at the same time by the depthwise convolution, each of the block units corresponds to a pixel point of an output image, and m<n/2;
in the depthwise convolution, computing a first result of a target pixel point in a target block unit in the first part by one multiplier in the first part, and computing a second result of the target pixel point in the second part by one multiplier in the second part; and

obtaining quantified results of the target block unit specific to the first part and the second part according to the first result and the second result of each target pixel point.

Optionally, the step of computing a first result of a target pixel point in a target block unit in the first part by one multiplier in the first part includes:
determining the target pixel point in the target block unit, wherein the target pixel point has a corresponding target pixel value;
determining a convolution kernel weight corresponding to the target pixel point in a convolution kernel corresponding to the input image according to a position of the target pixel point in the target block unit;
determining a product value of the target pixel value and the convolution kernel weight by one multiplier in the first part; and
taking the product value as the first result of the target pixel point in the first part.

Optionally, the step of computing a second result of the target pixel point in the second part by one multiplier in the second part includes:
acquiring an initial convolution kernel coefficient of the convolution kernel corresponding to the input image;
performing reverse operation on the complement of the initial convolution kernel coefficient to obtain a target convolution kernel coefficient;
determining the target pixel value of the target pixel point; and
multiplying the target convolution kernel coefficient with the target pixel value by one multiplier in the second part to obtain the second result of the target pixel point in the second part.

Optionally, the step of obtaining quantified results of the target block unit specific to the first part and the second part according to the first result and the second result of each target pixel point includes:
obtaining a pixel point result of the target pixel point according to an addition of the first result and the second result; and
performing addition on each pixel point result in the target block unit to obtain a total quantified result of the target block unit specific to the first part and the second part.

Optionally, a computational formula for the first result is expressed as:

S1 = q_{d} · q_{w}, wherein S1 is the first result, q_{d} is the target pixel value of the target pixel point, and q_{w} is the convolution kernel weight corresponding to the target pixel point.

Optionally, a computational formula for the second result is expressed as:

S2 = -Z_{W}q_{d}, wherein S2 is the second result, q_{d} is the target pixel value of the target pixel point, and Z_{w} is the convolution kernel coefficient.

Optionally, a computational formula for the quantified results is expressed as:
S = ∑(q_{d} · q_{w} - Z_{W}q_{d}), wherein S is a total quantified result; and
a computational formula for the total quantified result is changeable as S = ∑q_{d} · q_{w} - Z_{w} ∑ q_{d}.

In a second aspect, a quantitative computation apparatus applied to depthwise convolution is provided. The apparatus includes:
a determination module configured to determine n multipliers adopted for standard convolution in a preset part of quantitative computation, wherein n is the number of channels in the standard convolution;
a distribution module configured to equally distribute the n multipliers to a first part and a second part of depthwise convolution in the quantitative computation, wherein the first part is the same as the preset part, quantified results of m block units in an input image can be computed at the same time by the depthwise convolution, each of the block units corresponds to a pixel point of an output image, and m≤n/2;
a computation module configured to, in the depthwise convolution, compute a first result of a target pixel point in a target block unit in the first part by one multiplier in the first part, and compute a second result of the target pixel point in the second part by one multiplier in the second part; and
an obtaining module configured to obtain quantified results of the target block unit specific to the first part and the second part according to the first result and the second result of each target pixel point.

In a third aspect, provided is an electronic device including a processor, a communication interface, a memory and a communication bus, wherein intercommunication among the processor, the communication interface and the memory is completed by the communication bus;
the memory is configured to store a computer program; and
the processor is configured to implement the steps of any one of the above-mentioned method applied to depthwise convolution when executing the program stored in the memory.

In a fourth aspect, provided is a computer-readable storage medium, wherein a computer program is stored in the computer-readable storage medium, and the steps of any one of the above-mentioned method applied to depthwise convolution are implemented when the computer program stored in the memory is executed by a processor.

The embodiments of the present application have the beneficial effects:

in the present application, a server equally distributes the n multipliers in the preset part in the quantitative computation of the standard convolution to the first part and the second part in the quantitative computation of the depthwise convolution, in this way, each of the first part and the second part is distributed with n/2 multipliers. When quantified results of at least two block units are computed at the same time in the depthwise convolution, at most n/2 multipliers can be adopted, that is, quantified results of at most n/2 block units are computed at the same time, so that the computing efficiency is increased. In addition, compared with the prior art in which one multiplier in the first part and one multiplier in the second part of the standard convolution can be only utilized in the depthwise convolution, the present application has the advantages that (n-1) idle multipliers in the standard convolution are reasonably utilized while one multiplier in the second part is abandoned in the depthwise convolution, and resources of the multipliers are also utilized to the maximum extent.

Of course, all of above-mentioned advantages are not necessarily needed to be achieved at the same time when any product or method in the present application is implemented.

### BRIEF DESCRIPTION OF THE DRAWINGS

In order to describe the technical solutions in embodiments of the present application or in the prior art more clearly, the accompanying drawings needed for describing the embodiments or the prior art will be briefly introduced below. Apparently, those of ordinary skill in the art may still derive other accompanying drawings from these accompanying drawings without creative work.

FIG. 1 is a schematic diagram of a hardware environment of a quantitative computation method applied to depthwise convolution provided in an embodiment of the present application;

FIG. 2 is a process diagram of a quantitative computation method applied to depthwise convolution provided in an embodiment of the present application;

FIG. 3 is a schematic diagram of a convolution process of standard convolution provided in an embodiment of the present application;

FIG. 4 is a schematic diagram of a convolution process of depthwise convolution provided in an embodiment of the present application;

FIG. 5 is a schematic structural diagram of a quantitative computation apparatus applied to depthwise convolution provided in an embodiment of the present application; and

FIG. 6 is a schematic structural diagram of an electronic device provided in an embodiment of the present application.

### DETAILED DESCRIPTION OF THE INVENTION

T In order to make objectives, technical solutions and advantages of the embodiments of the present application clearer, the technical solutions in the embodiments of the present application will be described clearly and completely below in conjunction with the accompanying drawings in the embodiments of the present application. Apparently, the described embodiments are a part of the embodiments of the present application, not all the embodiments. Based on the embodiments of the present application, all other embodiments obtained by those of ordinary skill in the art without creative work shall fall within the protective scope of the present application.

In the subsequent description, a suffix such as “module”, “component” or “unit” used to represent elements is only intended to facilitate the description of the present application, but has no specific meanings. Therefore, “module” and “component” can be mixed.

In order to solve the problem mentioned in the background art, an embodiment of a quantitative computation method applied to depthwise convolution is provided according to one aspect of an embodiment of the present application.

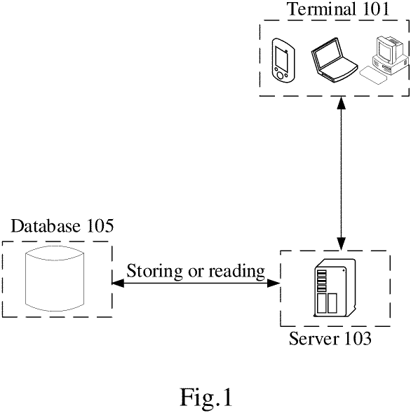

Optionally, in an embodiment of the present application, the above-mentioned quantitative computation method applied to depthwise convolution can be applied to a hardware environment formed by a terminal 101 and a server 103 as shown in FIG. 1. As shown in FIG. 1, the server 103 is connected to the terminal 101 by a network and may be used to provide service for the terminal or a client side mounted on the terminal, a database 105 may be disposed on the server or be independent of the server and may be used to provide data storage service for the server 103, the above-mentioned network includes, but is not limited to a wide area network, a metropolitan area network or a local area network, and the terminal 101 includes, but is not limited to a PC, a mobile phone and a tablet computer.

An embodiment of the present application provides a quantitative computation method applied to depthwise convolution, which may be applied to a server or a terminal and may be used to reduce waste of hardware resources during quantitative computation of the depthwise convolution.

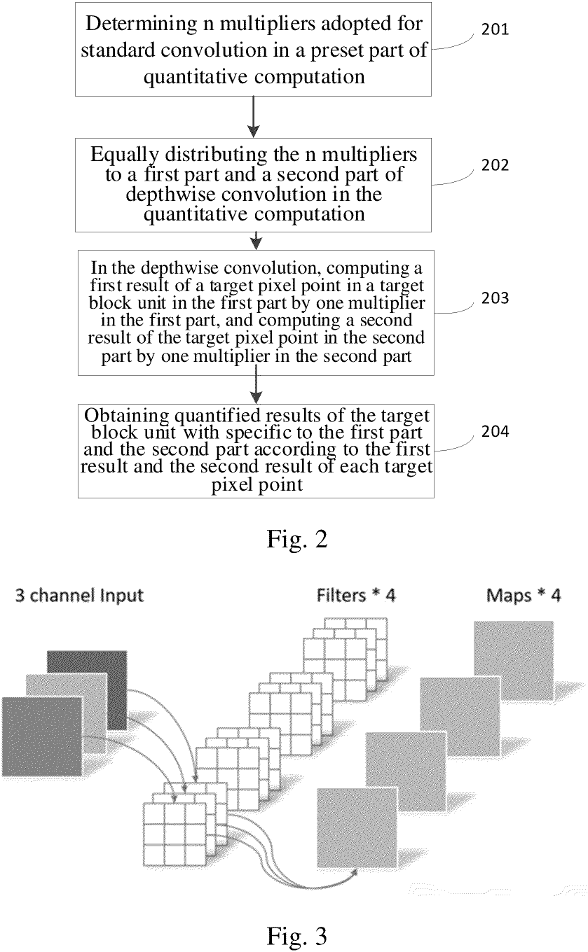

The quantitative computation method applied to depthwise convolution in an embodiment of the present application will be described in detail below in conjunction with specific implementations in an example in which it is applied to a server. As shown in FIG. 2, specific steps are described as follows.

Step 201: n multipliers adopted by standard convolution in a preset part of quantitative computation are determined.

Wherein n is the number of channels in the standard convolution.

In an embodiment of the present application, in the standard convolution, each convolution kernel operates all channels of an input image at the same time, and each convolution kernel corresponds to an output image, in this way, each output image embodies features of all the channels. FIG. 3 is a schematic diagram of a convolution process of the standard convolution. It can be seen that the input image includes three channels (channel input) (for example, an RGB image includes three channels R, G and B), and an output image (Maps) is obtained after a convolution operation of the convolution kernel (Filters).

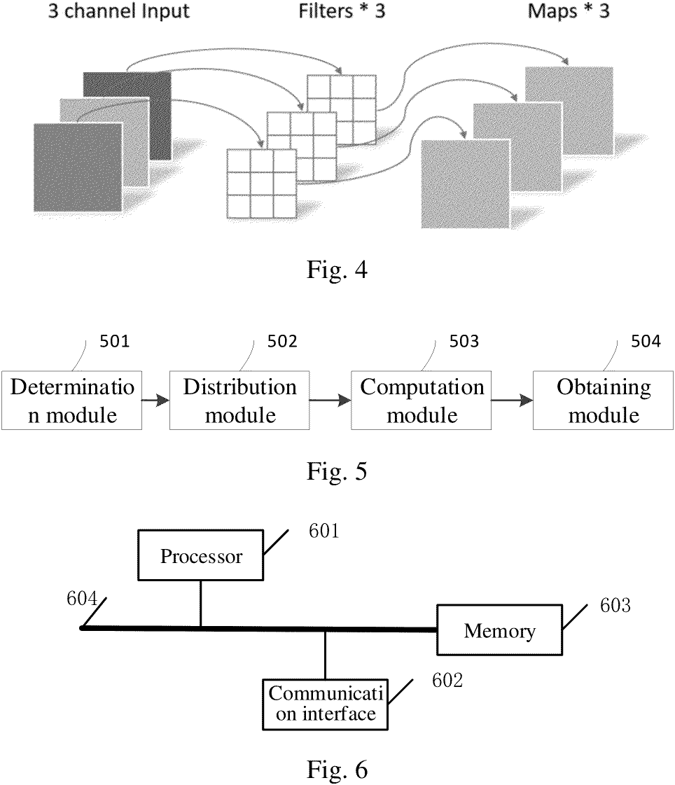

In depthwise convolution, each convolution kernel operates a channel of the input image, and each convolution kernel corresponds to an output image, in this way, each output image embodies features of a channel. FIG. 4 is a schematic diagram of a convolution process of the depthwise convolution. It can be seen that each convolution kernel is only responsible for one channel, and one channel is only convoluted by one convolution kernel.

A great number of parameters are needed in a model of a convolutional neural network, which will greatly increase the size of the model. However, an oversized model will increase the computation amount needed for neural network reasoning and can also increase demands on storage and a transmission bandwidth at the same time, and therefore, quantification is needed for reducing the data volume.

A common quantification way is to convert 32-bit floating-point data into an integer (usually 8 or 16 bits). A conversion formula is expressed as: r = S(q-Z), wherein r is original 32-bit floating-point data, S is a 32-bit floating-point multiplication coefficient, q is the integer obtained after conversion, and Z is a zero point. S and Z are quantification parameters, quantified results are determined by the two parameters.

In a quantification process, there may be accuracy loss which depends on a distribution range of the original data r, but the accuracy loss brought by this quantification process is within a range acceptable in the industry. quantification brings the advantage that the amount of data transmission is reduced (the quantification parameters are fixed in advance, and part of computation may be preprocessed, but is not needed to be processed in real time. With a quantified result being a 8-bit integer as an example, the amount of data transmission is reduced to ¼ of the original amount of data transmission). In addition, during quantitative computation, time and hardware resources consumed for computing the integer are both much smaller than a floating-point number, and therefore, by adopting quantitative operation, the computation speed can be increased, and the chip area and the power consumption can be reduced. The complexity of an algorithm can be lowered by quantification, thereby shortening the inference running time. A computational formula of convolution is expressed as rₒ = (∑r_{d} · r_{w})+bias which is substituted into a quantification formula r = S(q - Z)

so that rₒ = S_{w} S_{d} (∑ Z_{w} · Z_{d} - z_{d} ∑ )+ bias can be obtained. By using a substitution symbol

$$\text{S =} \frac{{\text{S}}_{w} {\text{S}}_{d}}{{\text{S}}_{o}} , \text{bias'=} \frac{\text{bias}}{{\text{S}}_{\text{w}} {\text{S}}_{d}} ,$$

a quantification formula for an output result can be obtained as qₒ = Zₒ +S(∑Z_{w} ·Z_{d} -Z_{d}∑q_{w} -Z_{w}∑q_{d} + ∑q_{d} ·q_{w} +bias’).

Specific meanings of all symbols in the above-mentioned quantification formula are shown as follows: ro represents original output data; r_{d} represents original input data; r_{w} represents an original coefficient; bias represents a constant; S_{w} represents a quantification coefficient of the coefficient and is a constant for an overall operation; S_{d} is a quantification coefficient of the input data and is a constant for an overall operation; So is a quantification coefficient of the output data and is a constant for an overall operation; Z_{w} is a quantification zero point of the coefficient and is a constant for an overall operation; Z_{d} is a quantification zero point of the input data and is a constant for an overall operation; Zₒ is a quantification zero point of the output data and is a constant for an overall operation; q_{w} is a quantified coefficient; q_{d} is quantified input data; and qₒ is quantified output data.

In a formula qₒ = Zₒ +S(∑Z_{w} ·Z_{d} -Z_{d}∑q_{w} -Z_{w}∑q_{d} + ∑q_{d} ·q_{w} +bias’), all data in ∑Z_{W} · Z_{d} - Z_{d}∑q_{w} + bias’ are constants determined in advance, and the remaining computation is divided into three parts:

a first part is ∑(q_{d}*q_{w} ), a second part is Z_{w}∑q_{d}, a third part is Zₒ +S(*), and the designs of hardware of the three parts are independent from each other.

For the computation in the first part, a computation process in the standard convolution is described as follows:

if a convolution kernel corresponding to a certain channel in a standard convolution operation is:

TABLE 1

| | | |
|---|---|---|
| W1 | W2 | W3 |
| W4 | W5 | W6 |
| W7 | W8 | W9 |

Input data corresponding to this channel is shown as:

TABLE 2

| | | | | | |
|---|---|---|---|---|---|
| D1 | D2 | D3 | D4 | D 5 | D6 |
| D7 | D8 | D9 | D10 | D11 | D12 |
| D13 | D14 | D15 | D16 | D17 | D18 |
| D19 | D20 | D21 | D22 | D23 | D24 |
| D25 | D26 | D27 | D28 | D29 | D30 |
| D31 | D32 | D33 | D34 | D35 | D36 |

The input image is divided into a plurality of block units overlapping incompletely, and the size of each block unit is the same as the size of the convolution kernel. It can be seen that the input image is divided according to a size of 3*3 to form table 2 which may be divided into 16 block units, wherein the circled part forms one block unit, and each block unit in the input image corresponds to a pixel point in the output image. For the standard convolution, firstly a result of one block unit is computed, and then, a result of the next block unit is computed until results of all the block units are completely computed. ∑(q_{d} · q_{w})is used to compute the result of the one block unit, wherein q_{d}^{q}^{d}, is data in table 2, and q_{w}is data in table 1.

Exemplarily, if ∑(q_{d} · q_{w})is used to compute the result of the first block unit,
in a first cycle, D1*W1 of n channels is computed (that is, D1*W1 is computed once for each channel), and results of all the channels are accumulated;
in a second cycle, D2*W2 of the n channels is computed, and results thereof are accumulated to a computed result obtained in the previous cycle;
...
in a ninth cycle, D15*W9 of the n channels is computed, and results thereof are accumulated to a computed result obtained in the previous cycle;
so far, a result of the first block unit is obtained.

It can be seen from the above-mentioned computation process that the Dx*Wx of the n channels is needed to be computed at the same time in a process of computing the result of the first block unit in the first part, a multiplier is needed when Dx*Wx of each channel is computed, and therefore, n multipliers are needed in the first part.

In an embodiment of the present application, if the size of the convolution kernel is 3*3, x is any number from 1 to 9. If the convolution kernel size is 5*5, x is any number from 1 to 25.

A computation process of the second part in the standard convolution is described as follows:

Z_{w}∑q_{d}, for the first block unit, the sum of D1 to D9 of each channel is needed to be computed, that is, ∑q_{d} is the sum of D1 to D9 of the n channels and is then multiplied by ^{Z}_{w} . Multiplication is performed once only, in this way, one multiplier is shared by all the channels in the second part.

Therefore, there are n multipliers in the first part and one multiplier in the second part of a computing system, and hardware of the computing system is fixed and is unchangeable.

For the depthwise convolution, on one hand, the convolution kernel of the depthwise convolution only corresponds to one channel, only one multiplier is needed in the first part of the depthwise convolution, and other (n-1) multipliers will be idle, which causes resource waste. On the other hand, the depthwise convolution itself may compute results of at least two block units at the same time, since there is only one multiplier in the second part of the computing system, only one multiplier can be adopted for computation in the depthwise convolution, which causes a low computing efficiency of the depthwise convolution.

A server determines the n multipliers adopted for the standard convolution in the preset part of the quantitative computation, wherein the preset part is the foregoing first part.

Step 202: the n multipliers are equally distributed to a first part and a second part of depthwise convolution in the quantitative computation.

Wherein the first part and the second part are both parts of formulae in quantification formulae, the first part is the same as the preset part, quantified results of m block units in an input image are computable at the same time by the depthwise convolution, each of the block units corresponds to a pixel point of an output image, and m≤n/2.

In an embodiment of the present application, the server equally distributes the n multipliers to the first part and the second part of the depthwise convolution in the quantitative computation, then, each of the first part and the second part of the depthwise convolution in the quantitative computation is configured with n/2 multipliers. The first part is∑(q_{d} ^{.} q_{w}), and the second part is Z_{w} Σ q_{d.}

When one block unit in the first part is computed in the depthwise convolution, the convolution kernel of the depthwise convolution only corresponds to one channel, and therefore, only one multiplier is needed for computing the one block unit in the first part of the depthwise convolution; and when one block unit in the second part is computed in the depthwise convolution, Z_{w} Σ q_{d} only needs one multiplier, and therefore, only one multiplier is needed for computing the one block unit in the second part of the depthwise convolution.

After the server is reconfigured with multipliers, there are n/2 multipliers in each of the first part and the second part of the depthwise convolution, at least two block units may be computed at the same time in the depthwise convolution, and therefore, the maximum number m of block units computed at the same time in the depthwise convolution should be less than or equal to n/2.

Step 203: in the depthwise convolution, a first result of a target pixel point in a target block unit in the first part is computed by one multiplier in the first part, and a second result of the target pixel point in the second part is computed by one multiplier in the second part.

In an embodiment of the present application, the server takes any one pixel point in the target block unit as the target pixel point. During the quantitative computation of the depthwise convolution, the server computes the first result of the target pixel point in the first part by one multiplier in the first part firstly, and then, computes the second result of the target pixel point in the second part by one multiplier in the second part. In this way, the server obtains the first result of the target pixel point in the first part and the second result of the target pixel point in the second part. The server may obtain the first result of each pixel point in the target block unit in the first part and the second result of each pixel point in the target block unit in the second part in this way.

Exemplarily, if a target pixel value of the target pixel point is D3, the first result in the first part is D3*W3, and the second result in the second part is Z_{W}* D3.

Step 204: quantified results of the target block unit specific to the first part and the second part are obtained according to the first result and the second result of each target pixel point.

In an embodiment of the present application, the server may obtain a pixel point result of the target pixel point by addition of the first result and the second result, the target block unit includes x pixel points, and the server obtains a total qualified result of the target block unit specific to the first part and the second part by addition of all the pixel point results in the target block unit.

In the present application, a server equally distributes the n multipliers in the preset part in the quantitative computation of the standard convolution to the first part and the second part in the quantitative computation of the depthwise convolution, in this way, each of the first part and the second part is distributed with n/2 multipliers. When quantified results of at least two block units are computed at the same time in the depthwise convolution, at most n/2 multipliers can be adopted, that is, quantified results of at most n/2 block units are computed at the same time, so that the computing efficiency is increased. In addition, compared with the prior art in which one multiplier in the first part and one multiplier in the second part of the standard convolution can be only utilized in the depthwise convolution, the present application has the advantages that (n-1) idle multipliers in the standard convolution are reasonably utilized while one multiplier in the second part is abandoned in the depthwise convolution, and resources of the multipliers are also utilized to the maximum extent.

For the problem of low computing efficiency of the depthwise convolution, if a plurality of block units are computed by only increasing a plurality of groups of Z, ∑ q_{d} .in the depthwise convolution, logics may be increased. In the present application, the number of selectors and the number of registers are increased, but the number of adders is not increased.

As an optional implementation, the step that a first result of a target pixel point in a target block unit in the first part is computed by one multiplier in the first part includes: the target pixel point in the target block unit is determined, wherein the target pixel point has a corresponding target pixel value; a convolution kernel weight corresponding to the target pixel point is determined in a convolution kernel corresponding to the input image according to a position of the target pixel point in the target block unit; a product value of the target pixel value and the convolution kernel weight is determined by one multiplier in the first part; and the product value is taken as the first result of the target pixel point in the first part.

In an embodiment of the present application, the convolution kernel corresponding to the input image includes a plurality of convolution kernel weights, the server takes any one pixel point in the target block unit as the target pixel point, then, determines the position of the target pixel point in the target block unit and determines the convolution kernel weight corresponding to the target pixel point according to the position. The server determines the product value of the target pixel value and the convolution kernel weight by one multiplier in the first part and takes the product value as the first result of the target pixel point in the first part.

A computational formula for the first result is expressed as:

S1= q_{d} ^{.} q_{w},, wherein S1 is the first result, ad is the target pixel value of the target pixel point, and q_{w} is the convolution kernel weight corresponding to the target pixel point.

As an optional implementation, the step that a second result of the target pixel point in the second part is computed by one multiplier in the second part includes: an initial convolution kernel coefficient of the convolution kernel corresponding to the input image is acquired; reverse operation is performed on the complement of initial convolution kernel coefficient to obtain a target convolution kernel coefficient; the target pixel value of the target pixel point is determined; and the target convolution kernel coefficient is multiplied with the target pixel value by one multiplier in the second part to obtain the second result of the target pixel point in the second part.

In an embodiment of the present application, the server acquires the initial convolution kernel coefficient Z_{w} of the convolution kernel corresponding to the input image, performs the reverse operation on complement of Z_{w} to obtain the target convolution kernel coefficient - Z_{w} and multiplies the target convolution kernel coefficient with the target pixel value by one multiplier in the second part to obtain the second result of the target pixel point in the second part.

A computational formula for the second result is expressed as:

S2 = -Z_{w}q_{d}^{,} wherein S2 is the second result, q_{d}is the target pixel value of the target pixel point, and Z_{W}, is the convolution kernel coefficient.

After the first result and the second result of the target pixel point are determined, a qualified result of the target block unit is the sum of all the pixel point results, that is, S = ∑(qₐ · q_{w} - Z_{w}q_{d}), wherein S is a total quantified result. A computational formula for the total quantified result is changeable as S = ∑ q_{d} · q_{w} - Z_{w}∑ q_{d} which is the same as a quantification formula in the standard convolution.

The first part and the second part adopt the same quantification formula in the standard convolution, the first part and the second part both exist in “*” of Zₒ + S(*), and therefore, the third part has no substantive changes.

Based on the same technical conception, an embodiment of the present application further provides a quantitative computation apparatus applied to depthwise convolution. As shown in FIG. 5, the apparatus includes:
a determination module 501 configured to determine n multipliers adopted for standard convolution in a preset part of quantitative computation, wherein n is the number of channels in the standard convolution;
a distribution module 502 configured to equally distribute the n multipliers to a first part and a second part of depthwise convolution in the quantitative computation, wherein the first part and the second part are both parts of formulae in quantification formulae, the first part is the same as the preset part, quantified results of m block units in an input image can be computed at the same time by the depthwise convolution, each of the block units corresponds to a pixel point of an output image, and m≤n/2;
a computation module 503 configured to, in the depthwise convolution, compute a first result of a target pixel point in a target block unit in the first part by one multiplier in the first part, and compute a second result of the target pixel point in the second part by one multiplier in the second part; and
an obtaining module 504 configured to obtain quantified results of the target block unit specific to the first part and the second part according to the first result and the second result of each target pixel point.

Optionally, the computation module 503 is configured to:
determine the target pixel point in the target block unit, wherein the target pixel point has a corresponding target pixel value;
determine a convolution kernel weight corresponding to the target pixel point in a convolution kernel corresponding to the input image according to a position of the target pixel point in the target block unit;
determine a product value of the target pixel value and the convolution kernel weight by one multiplier in the first part; and
take the product value as the first result of the target pixel point in the first part.

Optionally, the computation module 503 is further configured to:
acquire an initial convolution kernel coefficient of the convolution kernel corresponding to the input image;
perform reverse operation on the complement of the initial convolution kernel coefficient to obtain a target convolution kernel coefficient;
determine the target pixel value of the target pixel point; and
multiply the target convolution kernel coefficient with the target pixel value by one multiplier in the second part to obtain the second result of the target pixel point in the second part.

Optionally, the computation module 503 is configured to:
obtain a pixel point result of the target pixel point according to an addition of the first result and the second result; and
perform addition on each pixel point result in the target block unit to obtain a total quantified result of the target block unit specific to the first part and the second part.

Optionally, a computational formula for the first result is expressed as:

51 = q_{d} · q_{w}, wherein S1 is the first result, q_{d} is the target pixel value of the target pixel point, and q_{w} is the convolution kernel weight corresponding to the target pixel point.

Optionally, a computational formula for the second result is expressed as:

S2 = -Z_{w}q_{d}, wherein S2 is the second result, q_{d} is the target pixel value of the target pixel point, and Z_{W} is the convolution kernel coefficient.

Optionally, a computational formula for the quantified results is expressed as:
,S = ∑(q_{d} · q_{w}, - Z_{w} ∑ q_{d}) wherein S is a total quantified result; and
a computational formula for the total quantified result is changeable as S = Σq_{d} ^{.} q_{w} - Z_{W}Σq_{d} .

According to another aspect of an embodiment of the present application, the present application provides an electronic device, as shown in FIG. 6, including a memory 603, a processor 601, a communication interface 602 and a communication bus 604, wherein a computer program capable of running on the processor 601 is stored in the memory 603, communication between the memory 603 and the processor 601 is achieved by the communication interface 602 and the communication bus 604, and the processor 601 performs the steps of the above-mentioned method when executing the computer program.

In the above-mentioned electronic device, the communication between the memory and the processor is achieved by the communication bus and the communication interface. The communication bus may be a peripheral component interconnect (PCI for short) bus or an extended industry standard architecture (EISA for short) bus, etc. The communication bus may be divided into an address bus, a data bus, a control bus, etc.

The memory may include a random access memory (RAM for short) and may also include a non-volatile memory such as at least one disk memory. Optionally, the memory may also be at least one storage apparatus away from the above-mentioned processor.

The above-mentioned processor may be a general-purpose processor including a central processing unit (CPU for short), a network processor (NP for short), etc.; and it may also be a digital signal processor (DSP for short), an application specific integrated circuit (ASIC for short), a field-programmable gate array (FPGA for short) or other programmable logic devices, a discrete gate or a transistor logic device and a discrete hardware component.

A computer readable medium provided with a nonvolatile program code executable for a processor is further provided according to further aspect of an embodiment of the present application.

Optionally, in an embodiment of the present application, the computer readable medium is configured to store a program code for the processor to perform the above-mentioned method.

Optionally, specific examples in the present embodiment may refer to examples described in the above-mentioned embodiments, and the present embodiment is not repeated herein.

When being specifically implemented, the embodiments of the present application may refer to all of the above-mentioned embodiments and have the corresponding technical effects.

It can be understood that these embodiments described herein may be implemented by virtue of hardware, software, firmware, mid-ware, a microcode or a combination thereof. For hardware implementation, a processing unit may be implemented in one or more application specific integrated circuits (ASIC), a digital signal processor (DSP), a DSP device (DSPD), a programmable logic device (PLD), a field-programmable gate array (FPGA), a general-purpose processor, a controller, a micro-controller, a microprocessor and other electronic units for executing functions in the present application or a combination thereof.

For software implementation, the technology described herein may be implemented by a unit executing the functions described herein. A soft code may be stored in the memory and is executed by the processor. The memory may be implemented in the processor or outside the processor.

It can be recognized by those of ordinary skill in the art that the units and algorithm steps in all embodiments described in conjunction with the embodiments disclosed herein may be implemented by electronic hardware or a combination of computer software and the electronic hardware. Whether these functions are implemented by hardware or software depends upon specific applications and design constraints of the technical solutions. Professional technicians may adopt different methods to achieve the described functions in each specific application, which, however, should be considered as falling within the scope of the present application.

It can be clearly known by the skilled in the art that, in order to facilitate and simplify the description, specific working processes of the system, apparatus and unit described above may refer to the corresponding processes in the foregoing method embodiment, but will not be repeated herein.

In the embodiments provided by the present application, it should be understood that the disclosed apparatus and method may be implemented in other ways. For example, the described apparatus embodiment is only schematic. For example, the division of the modules is only the division of logic functions, there may be additional division ways during actual implementation. For example, a plurality of modules or components may be combined or integrated into another system or some features may be ignored or not be executed. In addition, the displayed or discussed inter-coupling or direct coupling or communication connection may be achieved by some interfaces, and indirect coupling or communication connection between apparatuses or units may be in an electric form, a mechanical form or other forms.

The units described as a separation component may be or not be physically separated, and a component serving as a display unit may be or not be a physical unit, that is, they may be located on the same place or distributed on a plurality of network units. Parts or all of the units may be selected according to an actual demand to achieve the objective of the solution in the present embodiment.

In addition, all the functional units in each embodiment of the present application may be integrated into one processing unit, or all the units physically exist alone, or two or more units are integrated into one unit.

When being complemented in a form of a software functional unit and is sold or used as an independent product, the functions may be stored in a computer-readable storage medium. Based on such understanding, the essences of the above-mentioned technical solutions in the embodiments of the present application or parts thereof making contributions to the prior art may be embodied in a form of a software product, and the computer software product is stored in a storage medium and includes a plurality of commands used to enable a computer device (which may be a personal computer, a server, or a network device, etc.) to perform all or parts of steps of the method in each of the embodiments of the present application. The foregoing storage medium includes various media such as a U disk, a mobile hard disk, an ROM, an RAM, a diskette or an optical disk capable of storing a program code. It should be noted that, herein, relational terms such as “first” and “second” are only used to distinguish one entity or operation from another one, but do not necessarily require or imply the presence of any such actual relationship or order between these entities or operations. Moreover, terms “includes”, “including” or any other variants thereof are intended to cover non-excludable inclusion, so that a process, a method, an article or a device including a series of elements not only includes those elements, but also includes other elements not listed clearly, or further includes inherent elements of this process, method, article or device. Under the condition that no more limitations are provided, elements defined by the word “including a...” do not exclude other same elements further existing in the process, method, article or device including the elements.

The above descriptions are merely specific implementations of the present application, which enables the skilled in the art to understand or implement the present application. Various amendments to these embodiments are obvious to those skilled in the art, and general principles defined in the present application may be achieved in the other embodiments without departing from the spirit or scope of the present application. Thus, the present application will not be limited to these embodiments shown herein, but shall accord with the widest scope consistent with the principles and novel characteristics of the present application.

1. A quantitative computation method applied to depthwise convolution, wherein the method comprises:
determining n multipliers adopted for standard convolution in a preset part of quantitative computation, wherein n is the number of channels in the standard convolution;
equally distributing the n multipliers to a first part and a second part of depthwise convolution in the quantitative computation, wherein the first part and the second part are both parts of formulae in quantification formulae, the first part is the same as the preset part, quantified results of m block units in an input image are computable at the same time by the depthwise convolution, each of the block units corresponds to a pixel point of an output image, and m<n/2;
in the depthwise convolution, computing a first result of a target pixel point in a target block unit in the first part by one multiplier in the first part, and computing a second result of the target pixel point in the second part by one multiplier in the second part; and
obtaining quantified results of the target block unit specific to the first part and the second part according to the first result and the second result of each target pixel point.

2. The method according to claim 1, wherein the step of computing a first result of a target pixel point in a target block unit in the first part by one multiplier in the first part comprises:
determining the target pixel point in the target block unit, wherein the target pixel point has a corresponding target pixel value;
determining a convolution kernel weight corresponding to the target pixel point in a convolution kernel corresponding to the input image according to a position of the target pixel point in the target block unit;
determining a product value of the target pixel value and the convolution kernel weight by one multiplier in the first part; and
taking the product value as the first result of the target pixel point in the first part.

3. The method according to claim 1, wherein the step of computing a second result of the target pixel point in the second part by one multiplier in the second part comprises:
acquiring an initial convolution kernel coefficient of the convolution kernel corresponding to the input image;
performing reverse operation on complement of the initial convolution kernel coefficient to obtain a target convolution kernel coefficient;
determining the target pixel value of the target pixel point; and
multiplying the target convolution kernel coefficient with the target pixel value by one multiplier in the second part to obtain the second result of the target pixel point in the second part.

4. The method according to claim 1, wherein the step of obtaining quantified results of the target block unit specific to the first part and the second part according to the first result and the second result of each target pixel point comprises:
obtaining a pixel point result of the target pixel point according to an addition of the first result and the second result; and
performing addition on each pixel point result in the target block unit to obtain a total quantified result of the target block unit specific to the first part and the second part.

5. The method according to claim 1, wherein a computational formula for the first result is expressed as:
S1 = q_{d} · q_{w}, wherein S1 is the first result, q_{d} is the target pixel value of the target pixel point, and q_{w} is the convolution kernel weight corresponding to the target pixel point.

6. The method according to claim 1, wherein a computational formula for the second result is expressed as:
S2 = -Z_{w}q_{d}, wherein S2 is the second result, q_{d} is the target pixel value of the target pixel point, and Z_{w} is the convolution kernel coefficient.

7. The method according to claim 1, wherein a computational formula for the quantified results is expressed as:
S = E(q_{d} · q_{w} - Z_{w}q_{q}), wherein S is a total quantified result; and
a computational formula for the total quantified result is changeable as S = Σq_{d} · q_{w} — Z_{W} Σ q_{d}.

8. A quantitative computation apparatus applied to depthwise convolution, wherein the apparatus comprises:
a determination module configured to determine n multipliers adopted for standard convolution in a preset part of quantitative computation, wherein n is the number of channels in the standard convolution;
a distribution module configured to equally distribute the n multipliers to a first part and a second part of depthwise convolution in the quantitative computation, wherein the first part is the same as the preset part, quantified results of m block units in an input image are computable at the same time by the depthwise convolution, each of the block units corresponds to a pixel point of an output image, and m≤n/2;
a computation module configured to, in the depthwise convolution, compute a first result of a target pixel point in a target block unit in the first part by one multiplier in the first part, and compute a second result of the target pixel point in the second part by one multiplier in the second part; and
an obtaining module configured to obtain quantified results of the target block unit specific to the first part and the second part according to the first result and the second result of each target pixel point.

9. An electronic device, comprising a processor, a communication interface, a memory and a communication bus, wherein intercommunication among the processor, the communication interface and the memory is completed by the communication bus;
the memory is configured to store a computer program; and
the processor is configured to implement the steps of the method according to claim 1 when executing the program stored in the memory.

10. The method according to claim 9, wherein the step of computing a first result of a target pixel point in a target block unit in the first part by one multiplier in the first part comprises:
determining the target pixel point in the target block unit, wherein the target pixel point has a corresponding target pixel value;
determining a convolution kernel weight corresponding to the target pixel point in a convolution kernel corresponding to the input image according to a position of the target pixel point in the target block unit;
determining a product value of the target pixel value and the convolution kernel weight by one multiplier in the first part; and
taking the product value as the first result of the target pixel point in the first part.

11. The method according to claim 9, wherein the step of computing a second result of the target pixel point in the second part by one multiplier in the second part comprises:
acquiring an initial convolution kernel coefficient of the convolution kernel corresponding to the input image;
performing reverse operation on complement of the initial convolution kernel coefficient to obtain a target convolution kernel coefficient;
determining the target pixel value of the target pixel point; and
multiplying the target convolution kernel coefficient with the target pixel value by one multiplier in the second part to obtain the second result of the target pixel point in the second part.

12. The method according to claim 9, wherein the step of obtaining quantified results of the target block unit specific to the first part and the second part according to the first result and the second result of each target pixel point comprises:
obtaining a pixel point result of the target pixel point according to an addition of the first result and the second result; and
performing addition on each pixel point result in the target block unit to obtain a total quantified result of the target block unit specific to the first part and the second part.

13. The method according to claim 9, wherein a computational formula for the first result is expressed as:
S1 = q_{d} ·q_{w}, wherein S1 is the first result, q_{d} is the target pixel value of the target pixel point, and q_{w} is the convolution kernel weight corresponding to the target pixel point.

14. The method according to claim 9, wherein a computational formula for the second result is expressed as:
S2 = -Z_{w}q_{d}, wherein S2 is the second result, q_{d} is the target pixel value of the target pixel point, and Z_{w} is the convolution kernel coefficient.

15. The method according to claim 9, wherein a computational formula for the quantified results is expressed as:
S = E(q_{d} · q_{w} - Z_{w}q_{q}), wherein S is a total quantified result; and
a computational formula for the total quantified result is changeable as S = Σ q_{d} · q_{w} - Z_{w}Σ q_{d}.
